(19) United States
(12) Patent Application Publication
(10) Pub. No.: US 2024/0088421 A1
(43) Pub. Date: Mar. 14, 2024

(54) FLOW BATTERY SYSTEMS AND METHODS

(71) Applicant: V-FLOW TECH PTE. LTD., Singapore (SG)

(72) Inventors: Arjun BHATTARAI, Singapore (SG); Avishek KUMAR, Singapore (SG)

(73) Assignee: V-FLOW TECH PTE. LTD., Singapore (SG)

(21) Appl. No.: 18/262,249

(22) PCT Filed: Jan. 21, 2022
(86) PCT No.: PCT/SG2022/050028

§ 371 Date: Jul. 20, 2023

(30) Foreign Application Priority Data
Jan. 21, 2021 (SG) 10202100660T

(51) Int. Cl. H01M 8/18; H01M 8/04537; H01M 8/04746; H01M 8/04858

(52) U.S. Cl. CPC H01M 8/188; H01M 8/04604; H01M 8/04746; H01M 8/04858

(57) ABSTRACT

Flow battery systems and control methods are disclosed. The flow battery includes components such as positive electrolyte tank, a negative electrolyte tank, a primary stack having a positive porous electrode and a negative porous electrode separated by a membrane, a power bus linked to the electrodes, an electrolyte pump and an auxiliary stack, etc. The power load on a power bus is monitored and as required pumps are activated if the detected power load on the power bus is greater than a first threshold power load. One of the pumps are deactivated if the detected power load on the power bus is less than a second threshold power load which is lower than the first threshold power load.

### TECHNICAL FIELD

The present disclosure relates to flow batteries and to methods of controlling flow batteries.

### BACKGROUND

Flow batteries such as vanadium redox flow batteries are recognized as a promising energy storage system (ESS) solution for large-scale renewable applications because of their high safety, long lifetime and low maintenance. The fast dynamic response and high life cycles ensure high performance of renewable intermittency mitigation without severe battery degradation. On the other hand, the independent power and energy capacities creates an opportunity for flexible system design with different power & energy requirements.

However, the typical operation efficiency of flow battery is 70-80%, which is a significant drawback that affects the economic benefit of renewable energies. In the context of reducing fuel pricing globally in recent years, high-efficiency flow battery systems for large-scale applications of renewable energy is becoming an enabling technology to fully uncover the economic potential of renewables.

### SUMMARY

The present disclosure provides flow battery systems with improved efficiency. Flow battery systems with multiple parallel stacks comprising a primary stack and one or more auxiliary stacks are provided. A controller of the flow battery system monitors a load power and switches between operation modes depending on the load power.

According a first aspect of the present invention, a flow battery system is provided. The flow battery system comprises: a positive electrolyte tank containing a positive electrolyte; a negative electrolyte tank containing a negative electrolyte; a primary stack comprising a positive porous electrode and a negative porous electrode separated by a membrane, the positive porous electrode of the primary stack and the negative porous electrode of the primary stack being coupled to a power bus; a primary stack positive electrolyte pump configured to pump positive electrolyte from the positive electrolyte tank though the positive electrode of the primary stack; a primary stack negative electrolyte pump configured to pump negative electrolyte from the negative electrolyte tank though the negative electrode of the primary stack; an auxiliary stack comprising a positive porous electrode and a negative porous electrode separated by a membrane, the positive porous electrode of the auxiliary stack and the negative porous electrode of the auxiliary stack being coupled to the power bus; an auxiliary stack positive electrolyte pump configured to pump positive electrolyte from the positive electrolyte tank though the positive electrode of the auxiliary stack; an auxiliary stack negative electrolyte pump configured to pump negative electrolyte from the negative electrolyte tank though the negative electrode of the auxiliary stack; and a controller configured to activate and deactivate the auxiliary stack positive electrolyte pump and the auxiliary stack negative electrolyte pump based on a detected power load on the power bus.

Embodiments of the flow battery system have the advantage of a 3-5% efficiency improvement over systems without smart switching between modes. Many conventional flow battery systems lack a smart pump management system and in such systems all pumps are consistently in operation regardless of the loading conditions. This lowers system efficiency (70-80%) since the overall battery system has to be subject to 3-5% pump power consumption at any operation condition. Flow battery systems described herein avoid this power consumption because some of the pumps may be deactivated under lower load conditions. Additionally, the primary and auxiliary stack design enables an economic mode to be enabled when both stacks are not required to supply the load because of light loading condition. Thus, embodiments of the flow battery system including smart pump and stack management can provide improved efficiency of up to 85% without performance sacrifice.

In an embodiment, the positive porous electrode of the auxiliary stack and the negative porous electrode of the auxiliary stack are coupled to the power bus by relays and the controller is configured to control switching of the relays based on the detected power load on the power bus.

In an embodiment, the controller is configured to activate the auxiliary stack positive electrolyte pump and the auxiliary stack negative electrolyte pump if the detected power load on the power bus is greater than a first threshold power load. The first threshold power load may be between 90% and 100% of the power rating of the primary stack.

In an embodiment, the controller is further configured to intermittently deactivate the primary stack positive electrolyte pump and the primary stack negative electrolyte pump if the detected power load on the power bus is less than a second threshold power load. The second threshold may be between 2% and 10% of the power rating of the primary stack.

In an embodiment, the controller is configured to intermittently deactivate the primary stack positive electrolyte pump and the primary stack negative electrolyte pump if the detected power load on the power bus is less than the second threshold power load such that over an hour period, the primary stack positive electrolyte pump and the primary stack negative electrolyte pump are deactivated for at least 50 minutes.

The time period for which the pumps are deactivated may vary depending on the system design. For example, deactivation time can be estimated based on the total energy contained inside the stack electrodes and auxiliary power consumption of battery management system components not including the pumps.

The flow battery system may be configured as a redox flow battery system. The flow battery system may be configured as a redox vanadium redox flow battery system.

According to a second aspect of the present disclosure, a flow battery system is provided. The flow battery system comprises: a positive electrolyte tank containing a positive electrolyte; a negative electrolyte tank containing a negative electrolyte; a primary stack comprising a positive porous electrode and a negative porous electrode separated by a membrane, the positive porous electrode of the primary stack and the negative porous electrode of the primary stack being coupled to a power bus; a primary stack positive electrolyte pump configured to pump positive electrolyte from the positive electrolyte tank though the positive electrode of the primary stack; a primary stack negative electrolyte pump configured to pump negative electrolyte from the negative electrolyte tank though the negative electrode of the primary stack; and a controller configured to intermittently deactivate the primary stack positive electrolyte pump and the primary stack negative electrolyte pump if the detected power load on the power bus is less than a second threshold power load.

The second threshold may be between 2% and 10% of the power rating of the primary stack.

In an embodiment, the controller is configured to intermittently deactivate the primary stack positive electrolyte pump and the primary stack negative electrolyte pump if the detected power load on the power bus is less than the second threshold power load such that over an hour period, the primary stack positive electrolyte pump and the primary stack negative electrolyte pump are deactivated for at least 50 minutes.

The flow battery system may be configured as a redox flow battery system. The flow battery system may be configured as a redox vanadium redox flow battery system.

According to a third aspect of the present disclosure a method of controlling a flow battery system is provided. The flow battery system comprises: a positive electrolyte tank containing a positive electrolyte; a negative electrolyte tank containing a negative electrolyte; a primary stack comprising a positive porous electrode and a negative porous electrode separated by a membrane, the positive porous electrode of the primary stack and the negative porous electrode of the primary stack being coupled to a power bus; a primary stack positive electrolyte pump configured to pump positive electrolyte from the positive electrolyte tank though the positive electrode of the primary stack; a primary stack negative electrolyte pump configured to pump negative electrolyte from the negative electrolyte tank though the negative electrode of the primary stack; an auxiliary stack comprising a positive porous electrode and a negative porous electrode separated by a membrane, the positive porous electrode of the auxiliary stack and the negative porous electrode of the auxiliary stack being coupled to the power bus; an auxiliary stack positive electrolyte pump configured to pump positive electrolyte from the positive electrolyte tank though the positive electrode of the auxiliary stack; and an auxiliary stack negative electrolyte pump configured to pump negative electrolyte from the negative electrolyte tank though the negative electrode of the auxiliary stack. The method comprises monitoring a detected power load on the power bus; and activating and deactivating the auxiliary stack positive electrolyte pump and the auxiliary stack negative electrolyte pump based on the detected power load.

In an embodiment, the positive porous electrode of the auxiliary stack and the negative porous electrode of the auxiliary stack are coupled to the power bus by relays and the method further comprises controlling switching of the relays based on the detected power load on the power bus.

In an embodiment, the method comprises activating the auxiliary stack positive electrolyte pump and the auxiliary stack negative electrolyte pump if the detected power bad on the power bus is greater than a first threshold power bad. The threshold power bad may be between 90% and 100% of the power rating of the primary stack.

In an embodiment, the method further comprises intermittently deactivating the primary stack positive electrolyte pump and the primary stack negative electrolyte pump if the detected power bad on the power bus is less than a second threshold power bad. The second threshold may be between 2% and 10% of the power rating of the primary stack.

In an embodiment, intermittently deactivating the primary stack positive electrolyte pump and the primary stack negative electrolyte pump if the detected power load on the power bus is less than a second threshold power load comprises, over an hour period, deactivating the primary stack positive electrolyte pump and the primary stack negative electrolyte pump for at least 50 minutes.

According to a fourth aspect of the present disclosure a method of controlling a flow battery system is provided. The flow battery system comprises: a positive electrolyte tank containing a positive electrolyte: a negative electrolyte tank containing a negative electrolyte; a primary stack comprising a positive porous electrode and a negative porous electrode separated by a membrane, the positive porous electrode of the primary stack and the negative porous electrode of the primary stack being coupled to a power bus; a primary stack positive electrolyte pump configured to pump positive electrolyte from the positive electrolyte tank though the positive electrode of the primary stack; and a primary stack negative electrolyte pump configured to pump negative electrolyte from the negative electrolyte tank though the negative electrode of the primary stack. The method comprises: intermittently deactivating the primary stack positive electrolyte pump and the primary stack negative electrolyte pump if the detected power load on the power bus is less than a second threshold power load.

The second threshold may be between 2% and 10% of the power rating of the primary stack.

In an embodiment, intermittently deactivating the primary stack positive electrolyte pump and the primary stack negative electrolyte pump if the detected power load on the power bus is less than a second threshold power load comprises, over an hour period, deactivating the primary stack positive electrolyte pump and the primary stack negative electrolyte pump for at least 50 minutes.

According to a fifth aspect of the present disclosure, a controller for a flow battery system is provided which is configured to control the flow battery system according to the method set out above.

### BRIEF DESCRIPTION OF THE DRAWINGS

In the following, embodiments of the present invention will be described as non-limiting examples with reference to the accompanying drawings in which:

FIG. 1 shows a flow battery system according to an embodiment of the present invention;

FIG. 2 shows operating modes of a flow battery system according to an embodiment of the present invention;

FIG. 3 is a flowchart showing a method operation of a controller of a flow battery system when selecting between a high power mode and an economic mode;

FIG. 4 shows a flow battery system according to an embodiment of the present invention operating in a high power mode;

FIG. 5 shows a flow battery system according to an embodiment of the present invention operating in an economic mode;

FIG. 6 is a flowchart showing a method operation of a controller of a flow battery system when selecting between an economic mode and a silent mode; and

FIG. 7 shows a flow battery system according to an embodiment of the present invention operating in a silent mode.

### DETAILED DESCRIPTION

The present disclosure provides a flow battery system with multiple stacks and pumps for each of the stacks. A controller of the system adapts the number of operating stacks and pumps to the load condition so that the power loss in redundant stacks and the power consumption by redundant pumps can be saved. The overall system efficiency can thus be improved. Systems are envisaged with a primary stack and one or more auxiliary stack. In the description below, a system with a primary stack and a single auxiliary stack is described for simplicity, however, it will be appreciated that the systems and methods may be adapted to provide for multiple auxiliary stacks.

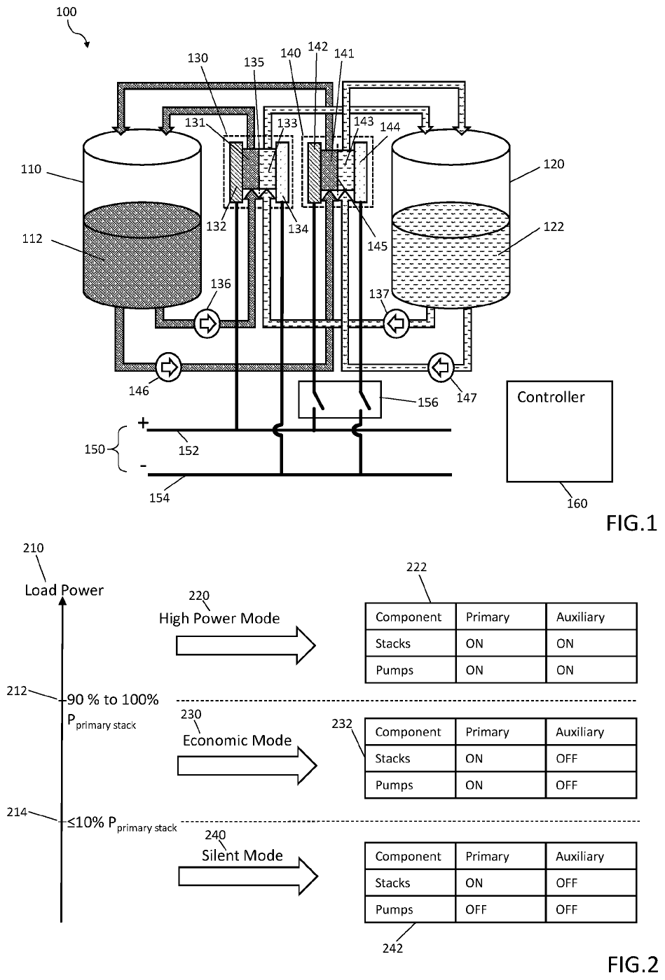

FIG. 1 shows a flow battery system according to an embodiment of the present invention. The flow battery system 100 comprises a positive electrolyte tank 110 holding a positive electrolyte 112 and a negative electrolyte tank 120 holding a negative electrolyte 122. The positive electrolyte 112 and the negative electrolyte may be vanadium-based electrolytes.

The flow battery system 100 further comprises a primary stack 130 and an auxiliary stack 140. The primary stack 130 comprises a positive porous electrode 131 and a negative porous electrode 132. The positive porous electrode 131 and the negative porous electrode 133 are separated by an ion exchange membrane 135. The positive porous electrode 131 is coupled to a positive electrode current collector 132 and the negative porous electrode 133 is coupled to a negative electrode current collector 134. Similarly, the auxiliary stack 140 comprises a positive porous electrode 141 and a negative porous electrode 142. The positive porous electrode 141 and the negative porous electrode 143 are separated by an ion exchange membrane 145. The positive porous electrode 141 is coupled to a positive electrode current collector 142 and the negative porous electrode 143 is coupled to a negative electrode current collector 144.

The primary stack 130 may be implemented as a single stack or primary string of stacks comprising a cluster of stacks supplied from common pump pair. Similarly, the auxiliary stack 140 may be implemented as a single stack or secondary string of stacks comprising a cluster of stacks supplied from common pump pair.

A primary stack positive electrolyte pump 136 is configured to pump the positive electrolyte 112 from the positive electrolyte tank 110 through the positive porous electrode 131 of the primary stack 130. A primary stack negative electrode pump 137 is configured to pump the negative electrolyte 122 from the negative electrolyte tank 120 through the negative porous electrode 133 of the primary stack 130. An auxiliary stack positive electrolyte pump 146 is configured to pump the positive electrolyte 112 from the positive electrolyte tank 110 through the positive porous electrode 141 of the auxiliary stack 140. An auxiliary stack negative electrode pump 147 is configured to pump the negative electrolyte 122 from the negative electrolyte tank 120 through the negative porous electrode 143 of the auxiliary stack 140.

The primary stack 130 and the auxiliary stack 140 are coupled to a power bus 150. The power bus 150 is a direct current bus having a positive power bus line 152 and a negative power bus line 154. The positive power bus line 152 is coupled to the positive electrode current collector 132 of the primary stack 130 and the positive electrode current collector 142 of the auxiliary stack 140. The negative power bus line 154 is coupled to the negative electrode current collector 134 of the primary stack 130 and the negative electrode current collector 144 of the auxiliary stack 140. As shown in FIG. 1, the connections from the power bus 150 to the positive electrode current collector 132 and the negative current collector 134 of the primary stack 130 are direct connections, while the connections from the power bus 150 to the positive electrode current collector 142 and the negative current collector 144 of the auxiliary stack 140 are through relays 156. The relays 156 allow the connections between the positive electrode current collector 142 and the negative current collector 144 of the auxiliary stack 140 and the power bus 150 to be switched on or off. The relays 156 may be provided as two separate relay devices or as one double pole single throw relay device controlling both the connection between the positive power bus line 152 and the positive electrode current collector 142 of the auxiliary stack 140 and the connection between the negative power bus line 154 and the negative electrode current collector 144 of the auxiliary stack 140.

The flow battery system 100 further comprises a controller 160 which controls the primary stack positive electrolyte pump 136, the primary stack negative electrode pump 137, auxiliary stack positive electrolyte pump 146, the auxiliary stack negative electrode pump 147 and the relays 156. The controller is also configured to determine the power load on the power bus 150 by sensing the voltage and current to determine the instant power flow from the flow battery system 100.

In operation, the controller 160 controls the primary stack positive electrolyte pump 136, the primary stack negative electrode pump 137, the auxiliary stack positive electrolyte pump 146, the auxiliary stack negative electrode pump 147 to cause electrolyte flow through the primary stack 130 and the auxiliary stack 140. When the positive electrolyte 112 flows through the positive porous electrode 131 and the negative electrode flows through the negative porous electrode 133 of the primary stack 130, ions in the positive electrolyte 112 within positive porous electrode 131 combine with electrons from the positive electrode current collector 132 and electrons are introduced into the negative current collector 134. This creates a current in the power bus 150. The same process occurs in the auxiliary stack 140 which is connected to the power bus 150 in parallel with the primary stack 130. After flowing through the respective positive or negative porous electrode, the electrolytes are returned to their respective electrolyte tank. In order to charge the flow battery system 100, the process described above is reversed.

When the flow battery system is supplying power, a load is connected to the power bus 150 which is driven by the current generated as described above. The controller 160 controls the flow battery system 100 to operate on one of a plurality of modes depending on the power of the load. Since the operation of the pumps requires power consumption, the efficiency of the flow battery system can be improved by switching some or all of the pumps off when a low power output is required from the flow battery system 100.

FIG. 2 shows operating modes of a flow battery system according to an embodiment of the present invention. FIG. 2 shows how the controller 160 controls the pumps and the relays 156 to operate the flow battery system 100 according to the detected power load on the power bus 150.

As shown in FIG. 2, the detected power load 210 is detected by the controller 160 and compared with a first power load threshold 212 and a second power load threshold 214. In the example shown in FIG. 2, the first power load threshold is 90% to 100% of the power output of the primary stack 130 or the auxiliary stack 140. Here is assumed that the power rating of each of the primary stack 130 and the auxiliary stack 140 is P_{primary stack}. In the example shown in FIG. 2, the second threshold 214 is a value less than or equal to 10% P_{primary stack}. If the detected power load 210 is above the first threshold 212, the controller 160 controls the flow battery system 100 to operate in a high power mode 220 according a high power mode set of configuration settings 222. If the detected power load 210 is below the first threshold 212 and above the second threshold 214, then the controller 160 controls the flow battery system 100 to operate in an economic mode 230 according an economic mode set of configuration settings 232. If detected power load 210 is below the second threshold 214, then the controller 160 controls the flow battery system 100 to operate in a silent mode 240 according to a silent mode set of configuration settings 242.

The high power mode set of configuration settings 222 specify that both the primary stack 130 and the auxiliary stack 140 are connected to the power bus 150 and that both the primary stack pumps (the primary stack positive electrolyte pump 136 and the primary stack negative electrode pump 137) and the auxiliary stack pumps (the auxiliary stack positive electrolyte pump 146 and the auxiliary stack negative electrode pump 147) are activated. Thus, both the primary stack 130 and the auxiliary stack 140 provide power to the power bus as the load is above the first threshold 212.

The economic mode set of configuration settings 232 specify that the primary stack 130 is connected to the power bus 150 and the auxiliary stack 140 is disconnected from the power bus 150. Further, the economic mode set of configuration settings 232 specify that the primary stack pumps (the primary stack positive electrolyte pump 136 and the primary stack negative electrode pump 137) are activated and the auxiliary stack pumps (the auxiliary stack positive electrolyte pump 146 and the auxiliary stack negative electrode pump 147) are deactivated. Since the load on the power bus 150 is below the first threshold 212, sufficient power can be provided by the primary stack 130 alone and thus the auxiliary stack pumps can be deactivated to save power.

The silent mode set of configuration settings 242 specify that specify that the primary stack 130 is connected to the power bus 150 and the auxiliary stack 140 is disconnected from the power bus 150. Further, the silent mode set of configuration settings 232 specify that both the primary stack pumps (the primary stack positive electrolyte pump 136 and the primary stack negative electrode pump 137) and the auxiliary stack pumps (the auxiliary stack positive electrolyte pump 146 and the auxiliary stack negative electrode pump 147) are deactivated. As will be described in more detail below, the primary stack pumps may be intermittently deactivated, that is, the primary stack pumps may be activated for short periods of time. The silent mode 240 is activated when the power load is very low, this may be for example during nighttime. When the power load is very low, the positive electrolyte 112 and negative electrolyte 122 within the primary stack 130 is sufficient to meet the power load without the requirement for fresh electrolyte to be constantly provided from the positive electrolyte tank 110 and the negative electrolyte tank 120. The primary stack pumps may be activated intermittently to refresh the positive electrolyte 112 and negative electrolyte 122 within the primary stack 130.

It is envisaged that the values of the first threshold 212 and the second threshold 214 may vary from those shown in FIG. 2. For example, the first threshold 212 may be between 90% of the power rating of the power rating of the primary stack and 100% of the power rating of the primary stack. Similarly, the second threshold 214 may be between 2% and 10% of the power rating of the primary stack.

In some embodiments, the relays 156 may be omitted from the flow battery system 100. In such embodiments, the auxiliary stack 140 would be connected to the power bus 150 even when the flow battery system operates under the economic mode 230 or the silent mode 240. In such an embodiment, there would still be an increase in efficiency in the economic mode 230 or the silent mode 240 since the auxiliary stack pumps would be deactivated.

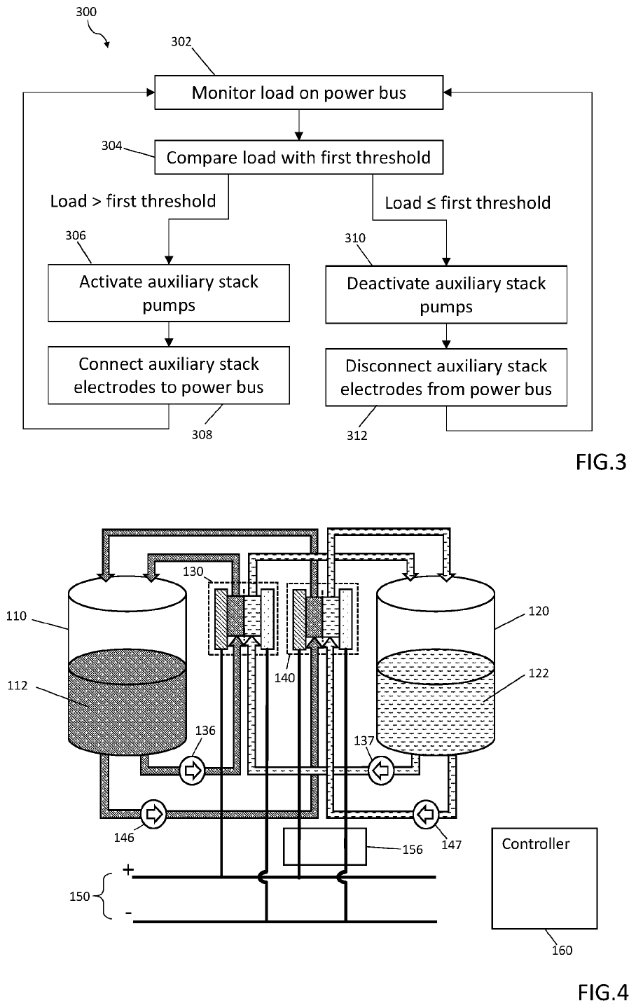

FIG. 3 is a flowchart showing a method operation of a controller of a flow battery system when selecting between a high power mode and an economic mode.

The method 300 shown in FIG. 3 is carried out by the controller 160 of the flow battery system 100 shown in FIG. 1. In step 302, the controller 160 monitors the power load on the power bus 150. In step 304, the controller compares the power load with the first threshold 212. As described above, the first threshold 212 may be 100% of the power rating of the primary stack, or may be between 90% and 100% of the power rating of the primary stack.

If the power load is greater than the first threshold 212, then the method moves to step 306 in which the controller 160 activates the auxiliary stack positive electrolyte pump 146 and the auxiliary stack negative electrode pump 147. The method then moves to step 308 in which the controller 160 controls the relays 156 to connect the auxiliary stack 140 to the power bus 150. Following step 308, the method returns to step 302.

If the power load is less than or equal to the first threshold 212, then the method moves to step 310 in which the in which the controller 160 deactivates the auxiliary stack positive electrolyte pump 146 and the auxiliary stack negative electrode pump 147. The method then moves to step 312 in which the controller 160 controls the relays 156 to disconnect the auxiliary stack 140 to the power bus 150. Following step 312, the method returns to step 302.

FIG. 4 shows a flow battery system according to an embodiment of the present invention operating in a high power mode.

As shown in FIG. 4, the controller 160 controls the flow battery system such that both the primary stack pumps (the primary stack positive electrolyte pump 136 and the primary stack negative electrode pump 137) and the auxiliary stack pumps (the auxiliary stack positive electrolyte pump 146 and the auxiliary stack negative electrode pump 147) are activated and the controls the relays 156 to connect the auxiliary stack 140 to the power bus 150. Therefore, the positive electrolyte 112 is pumped from the positive electrolyte tank 110 through both the primary stack 130 and the auxiliary stack, and the negative electrolyte 122 is pumped from the negative electrolyte tank 120 through both the primary stack 130 and the auxiliary stack. Therefore, both the primary stack 130 and the auxiliary stack 140 discharge power to the power bus 150 in the high power mode.

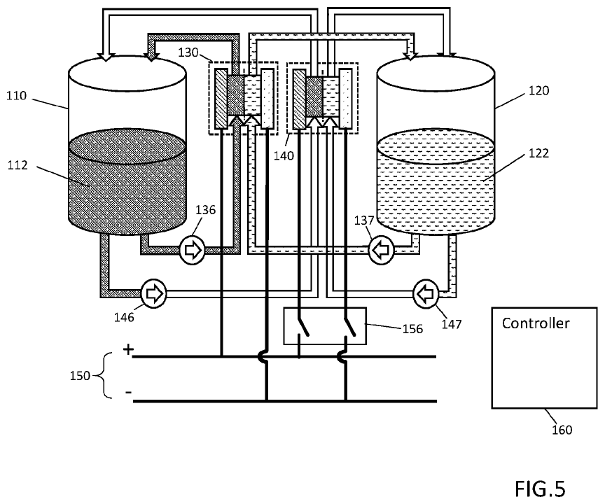

FIG. 5 shows a flow battery system according to an embodiment of the present invention operating in an economic mode.

As shown in FIG. 5, the controller 160 controls the flow battery system such that the primary stack pumps (the primary stack positive electrolyte pump 136 and the primary stack negative electrode pump 137) are activated and the auxiliary stack pumps (the auxiliary stack positive electrolyte pump 146 and the auxiliary stack negative electrode pump 147) are deactivated and the controls the relays 156 to disconnect the auxiliary stack 140 to the power bus 150. Therefore, the positive electrolyte 112 is pumped from the positive electrolyte tank 110 through the primary stack 130, and the negative electrolyte 122 is pumped from the negative electrolyte tank 120 through the primary stack 130. Therefore, only the primary stack 130 discharges power to the power bus 150.

If the load on the power bus 150 drops below the first threshold 212, the controller 140 is programmed to turn off the relays 156 and the auxiliary stack pumps (the auxiliary stack positive electrolyte pump 146 and the auxiliary stack negative electrode pump 147) since the primary stack 130 is capable of supplying the lighter load. The flow battery system is operating in economic mode 230 at this moment. Once the controller 160 detects the power load increasing above the first threshold 212, the auxiliary stack 140 and the auxiliary stack pumps are activated again to supply the heavier load together with primary stack 130 and therefore the high power mode 220 is enabled again.

One potential concern for this scenario is the switch over dynamic response between economic mode 230 and high power mode 220. Once the load suddenly increases above the first threshold 212, the primary stack 130 will respond first to follow the load change and operate in an over-current discharging status because of the fast response of the primary stack 130. The mechanical relays 156 on the auxiliary stack 140 side will be subsequently turned on by the controller 160 upon the detection of sudden load increasing. Normally, the response time of the mechanical relays 156 is around 10-20 ms. Owing to the over-current discharging capability, the primary stack 130 is capable of running with over-current for a while (much longer than 10-20 ms). Therefore, the dynamic transition between economic mode 230 and high power mode 220 is not time-sensitive.

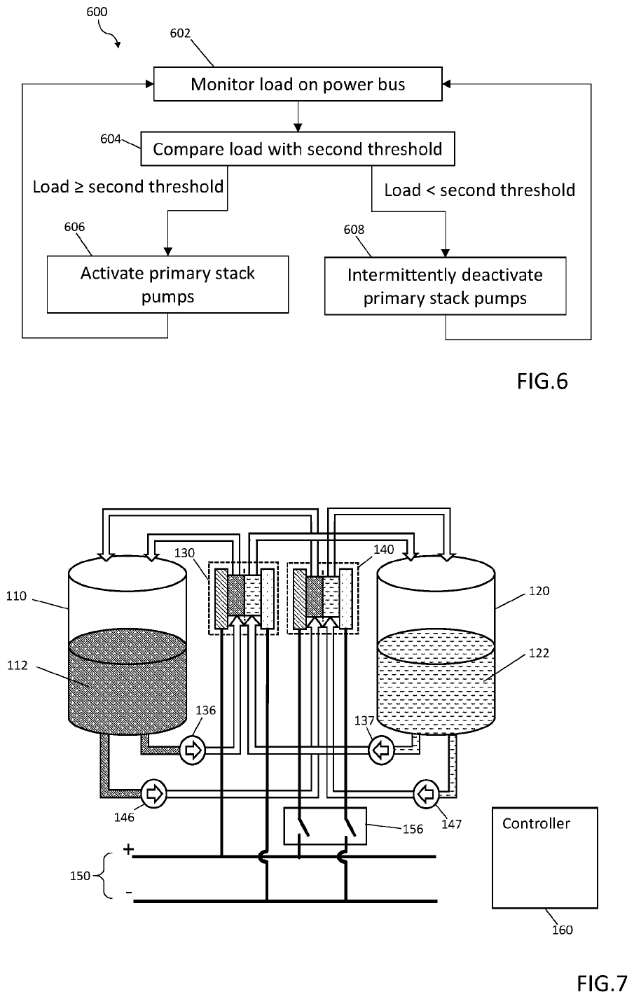

FIG. 6 is a flowchart showing a method operation of a controller of a flow battery system when selecting between an economic mode and a silent mode.

The method 600 shown in FIG. 6 is carried out by the controller 160 of the flow battery system 100 shown in FIG. 1. In step 602, the controller 160 monitors the power load on the power bus 150. In step 604, the controller compares the power load with the second threshold 214. As described above, the second threshold 216 may be 10% of the power rating of the primary stack, or may be between 2% and 10% of the power rating of the primary stack.

If the power load is greater than or equal to the second threshold 214, then the method moves to step 606 in which the controller 160 activates the primary stack positive electrolyte pump 136 and the auxiliary stack negative electrode pump 137. Following step 606, the method returns to step 602.

If the power load is less than the second threshold 214, then the method moves to step 608 in which the in which the controller 160 intermittently deactivates the primary stack positive electrolyte pump 136 and the auxiliary stack negative electrode pump 137. In step 608, the controller 160 controls the power supply to the primary stack pumps (the primary stack positive electrolyte pump 136 and the auxiliary stack negative electrode pump 137) such that they are deactivated the majority of the time but operated intermittently. Specifically, the controller 160 activates the primary pumps for 1 to 10 minutes each hour. Thus, the primary pumps are deactivated for at least 50 minutes of over an hour period. Following step 608, the method returns to step 602.

FIG. 7 shows a flow battery system according to an embodiment of the present invention operating in a silent mode.

As shown in FIG. 7, the controller 160 controls the flow battery system such that the primary stack pumps (the primary stack positive electrolyte pump 136 and the primary stack negative electrode pump 137) are deactivated for a majority of the time and the auxiliary stack pumps (the auxiliary stack positive electrolyte pump 146 and the auxiliary stack negative electrode pump 147) are also deactivated and the controls the relays 156 to disconnect the auxiliary stack 140 to the power bus 150. Therefore, for the majority of the time no positive electrolyte 112 flows from the positive electrolyte tank 110 to either the primary stack 130 or the auxiliary stack 140 and no negative electrolyte 122 flows from the negative electrolyte tank 120 to either the primary stack 130 or the auxiliary stack 140. Thus, the only power discharged is that provided by the electrolyte contained within the primary stack 130. The controller 160 intermittently operates the primary stack pumps (the primary stack positive electrolyte pump 136 and the primary stack negative electrode pump 137) so that the electrolyte in the primary stack 130 is refreshed.

If the load drops to an ultra-low level (e.g. below 2-10% of P_{stack}), which may occur during the night time when most of the major loads are off, the controller 160 is programmed to activate the silent mode and turn off the connection between the auxiliary stack 140 and the power bus 150, the primary stack pumps, and the auxiliary stack pumps. The only power module to supply the ultra-low load is the primary stack 130 without running pumps.

One concern for this scenario is supply continuity since the energy stored in the primary stack 130 is limited by its size. From testing, a 5 kW stack with voltage range of 40-60V is capable of supplying a 200W load for 30-60 mins without significant voltage drop. With this in mind, the silent mode with intermittent pump activation is proposed. Specifically, the controller 160 is programmed to turn on the primary stack pumps for 1-10 mins hourly so that the stored energy inside the primary stack 130 can be supplemented periodically.

Likewise, a potential concern for this scheme is the mode-switch dynamic response between silent mode and economic mode in the event that the load suddenly increases above the second threshold 214. Once the load suddenly increases above the second threshold 214, the primary stack 130 will respond first to follow the load change because of the fast response of the primary stack 130. The primary stack pumps will then subsequently be turn on by the controller 160 upon the detection of sudden load increase. The primary stack pumps are controlled by mechanical relays, whose response time is around 10-20 ms. Owing to the intermittent silent mode, the primary stack 130 will not lack energy at any instant and it is capable of following changing load for a while (much longer than 10-20 ms). Therefore, the dynamic transition between the silent mode 240 and the economic mode 230 is not time-sensitive.

It is envisaged that the flow battery systems and control methods described above may find applications in household photovoltaic/battery/utility systems, net-zero building systems, on-board ship microgrid systems including renewal energy and energy storage, remote or island based microgrid systems for distributed generator optimization, and emergency power systems including uninterruptable power systems.

It is envisaged that the systems and operating modes described above may be provided together or separately in flow battery systems. For example, a flow battery system having primary and auxiliary stacks may be provided with a controller that allows operation under all three of the operating modes (high power mode, economic mode and silent mode), or combinations of two of these operating modes. Further, the silent operating mode may be provided in a flow battery system having only a primary stack. In such a system which would have two pumps, a normal operating mode many be provided in which the pumps supplying the stack with electrolyte are activated constantly and a silent mode may be provided in which the pumps are activated only intermittently as described above.

In addition, flow battery systems with multiple auxiliary stacks may be provided and in such systems multiple high power modes may be implemented with the number of active auxiliary stacks controlled according to the power load.

Whilst the foregoing description has described exemplary embodiments, it will be understood by those skilled in the art that many variations of the embodiments can be made within the scope and spirit of the present invention.

1. A flow battery system comprising:
a positive electrolyte tank containing a positive electrolyte;
a negative electrolyte tank containing a negative electrolyte;
a primary stack comprising a positive porous electrode and a negative porous electrode separated by a membrane, the positive porous electrode of the primary stack and the negative porous electrode of the primary stack being coupled to a power bus;
a primary stack positive electrolyte pump configured to pump positive electrolyte from the positive electrolyte tank though the positive electrode of the primary stack;
a primary stack negative electrolyte pump configured to pump negative electrolyte from the negative electrolyte tank though the negative electrode of the primary stack;
an auxiliary stack comprising a positive porous electrode and a negative porous electrode separated by a membrane, the positive porous electrode of the auxiliary stack and the negative porous electrode of the auxiliary stack being coupled to the power bus;
an auxiliary stack positive electrolyte pump configured to pump positive electrolyte from the positive electrolyte tank though the positive electrode of the auxiliary stack;
an auxiliary stack negative electrolyte pump configured to pump negative electrolyte from the negative electrolyte tank though the negative electrode of the auxiliary stack; and
a controller configured to activate and deactivate the primary stack positive electrolyte pump, the primary stack negative electrolyte pump, the auxiliary stack positive electrolyte pump, and the auxiliary stack negative electrolyte pump based on a detected power load on the power bus,
wherein the controller is configured to activate the auxiliary stack positive electrolyte pump and the auxiliary stack negative electrolyte pump if the detected power load on the power bus is greater than a first threshold power load, and to intermittently deactivate the primary stack positive electrolyte pump and the primary stack negative electrolyte pump if the detected power load on the power bus is less than a second threshold power load which is lower than the first threshold power load,
wherein when the primary stack positive electrolyte pump and the primary stack negative electrolyte pump are deactivated, power is supplied to the power bus from the positive electrolyte within the positive porous electrode of the primary stack and the negative electrolyte within the negative porous electrode of the primary stack.

2. The flow battery system according to of claim 1, wherein the positive porous electrode of the auxiliary stack and the negative porous electrode of the auxiliary stack are coupled to the power bus by relays and the controller is configured to control switching of the relays based on the detected power load on the power bus.

3. The flow battery system of claim 1, wherein the threshold power load is between 90% and 100% of the power rating of the primary stack.

4. The flow battery system of claim 1, wherein the second threshold is between 2% and 10% of the power rating of the primary stack.

5. The flow battery system of claim 4, wherein the controller is configured to intermittently deactivate the primary stack positive electrolyte pump and the primary stack negative electrolyte pump if the detected power load on the power bus is less than the second threshold power load such that over an hour period, the primary stack positive electrolyte pump and the primary stack negative electrolyte pump are deactivated for at least 50 minutes.

6. (canceled)

7. (canceled)

8. A method of controlling a flow battery system, the flow battery system comprising:
a positive electrolyte tank containing a positive electrolyte;
a negative electrolyte tank containing a negative electrolyte;
a primary stack comprising a positive porous electrode and a negative porous electrode separated by a membrane, the positive porous electrode of the primary stack and the negative porous electrode of the primary stack being coupled to a power bus;
a primary stack positive electrolyte pump configured to pump positive electrolyte from the positive electrolyte tank though the positive electrode of the primary stack;
a primary stack negative electrolyte pump configured to pump negative electrolyte from the negative electrolyte tank though the negative electrode of the primary stack;
an auxiliary stack comprising a positive porous electrode and a negative porous electrode separated by a membrane, the positive porous electrode of the auxiliary stack and the negative porous electrode of the auxiliary stack being coupled to the power bus;
an auxiliary stack positive electrolyte pump configured to pump positive electrolyte from the positive electrolyte tank though the positive electrode of the auxiliary stack; and
an auxiliary stack negative electrolyte pump configured to pump negative electrolyte from the negative electrolyte tank though the negative electrode of the auxiliary stack;
the method comprising:
monitoring a detected power load on the power bus;
activating the auxiliary stack positive electrolyte pump and the auxiliary stack negative electrolyte pump if the detected power load on the power bus is greater than a first threshold power load; and
intermittently deactivating the primary stack positive electrolyte pump and the primary stack negative electrolyte pump if the detected power load on the power bus is less than a second threshold power load which is lower than the first threshold power load,
wherein when the primary stack positive electrolyte pump and the primary stack negative electrolyte pump are deactivated, power is supplied to the power bus from the positive electrolyte within the positive porous electrode of the primary stack and the negative electrolyte within the negative porous electrode of the primary stack.

9. The method of claim 8, wherein the positive porous electrode of the auxiliary stack and the negative porous electrode of the auxiliary stack are coupled to the power bus by relays and the method further comprises controlling switching of the relays based on the detected power load on the power bus.

10. The method of claim 8, wherein the first threshold power load is between 90% and 100% of the power rating of the primary stack.

11. The method according to claim 8, wherein the second threshold is between 2% and 10% of the power rating of the primary stack.

12. The method of claim 11, wherein intermittently deactivating the primary stack positive electrolyte pump and the primary stack negative electrolyte pump if the detected power load on the power bus is less than a second threshold power load comprises, over an hour period, deactivating the primary stack positive electrolyte pump and the primary stack negative electrolyte pump for at least 50 minutes.

13. (canceled)
